(19) United States
(12) Patent Application Publication
(10) Pub. No.: US 2008/0267581 A1
(43) Pub. Date: Oct. 30, 2008

(54) METHOD FOR EDITING LIST OF MOVING IMAGE FILES

(75) Inventor: Tae Hyung KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/048,716

(22) Filed: Mar. 14, 2008

(30) Foreign Application Priority Data
Apr. 24, 2007 (KR) 2007-0039762

(51) Int. Cl. G11B 27/00

(52) U.S. Cl. 386/52

(57) ABSTRACT

A method for editing a list of moving image files is disclosed. The method edits thumbnail images representing the moving image files in the list. The method includes generating a thumbnail image from displayed frames, when a selection signal is input during the playback of a moving image file; storing the thumbnail image and information related to the thumbnail image; and displaying the thumbnail image, using the thumbnail image-related information, when the list of the moving image file is displayed. The method can display the contents of moving image files in the list, so that a user can easily play back his/her desired moving image file.

### PRIORITY

This application claims priority under 35 U.S.C. §119(a) to an application entitled “METHOD FOR EDITING LIST OF MOVING IMAGE FILES” filed in the Korean Intellectual Property Office on Apr. 24, 2007 and assigned Serial No. 2007-0039762, the contents of which are incorporated herein by reference.

### BACKGROUND OF THE INVENTION

1. Field of the Invention

The present invention relates to a method for providing a list of moving image files, and in particular, to a method for editing thumbnail images representing moving images whose files form a list.

2. Description of the Related Art

Recording media, such as a Compact Disk (CD) or a Digital-Video Disk (DVD), records moving images that are processed by a coding or compression algorithm, which is proposed by a Moving Picture Engineer Group (MPEG). To play back the moving images, a playback device reads coded data from the recording media and decodes the read data into the original data.

The coding algorithm uses intra-frame coding and inter-frame coding to process and record moving images. The intra-frame coding can reduce the spatial redundancy of successive frames, and restore a frame with reference only to the information of the frame itself. The inter-frame coding serves to reduce the temporal redundancy between frames, and compresses a current frame based on a difference between a previous frame and a predictive frame. Although the inter-frame coding cannot restore a frame using inter-frame coding information only, it can remarkably reduce the amount of information.

The conventional digital moving image playback apparatus displays a list of moving image files stored in the recoding media as thumbnail images that each of the image is created by decoding the first I-frame or any other I-frame in a corresponding moving image. However, if the first I-frame or any other I-frame has low brightness, a user would have difficulty of clearly checking the moving image files represented as thumbnail images in the list. Therefore, a technique is required to edit the thumbnail images representing the moving image files.

### SUMMARY OF THE INVENTION

An object of the present invention is to solve at least the above problems, and therefore, the present invention provides a method that edits thumbnail images, which are representing moving image files when a list of the moving image files is displayed.

The present invention further provides a method for setting a successive playback screen of moving images.

In accordance with the present invention, a method for editing a list of moving image files includes generating a thumbnail image from displayed frames, when a selection signal is input during the playback of a moving image file; storing the thumbnail image and information related to the thumbnail image; and displaying the thumbnail image, using the thumbnail image-related information, when the list of the moving image files is displayed.

### BRIEF DESCRIPTION OF THE DRAWINGS

The objects, features, and advantages of the present invention will become more apparent from the following detailed description when taken in conjunction with the accompanying drawings, in which:

FIG. 1 is a block diagram depicting an apparatus for playing back moving image files, which adopts a method for editing a list of moving image files according to the present invention;

FIG. 2 is a detailed view depicting the controller of FIG. 1;

FIG. 3 is a flow chart illustrating a method for editing a list of moving image files according to the present invention;

FIG. 4 is a flow chart illustrating a process for performing a successive playback function of FIG. 3;

FIG. 5 is a flow chart illustrating a process for setting a successive playback function of FIG. 3;

FIG. 6 is a flow chart illustrating a processing for capturing a displayed frame of FIG. 3;

FIG. 7 is a screen displaying a method for editing a list of moving image files according to the present invention; and

FIG. 8 is a screen displaying a method for editing a list of moving image files according to another embodiment of the present invention.

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

The embodiment of the present invention will be described based on a moving image compressed by the Moving Picture Engineer Group (MPEG) standard, in particular, an I-frame. Therefore, it should be understood that the present invention can be applied to other moving images processed by a general compression algorithm other than the MPEG compression algorithm.

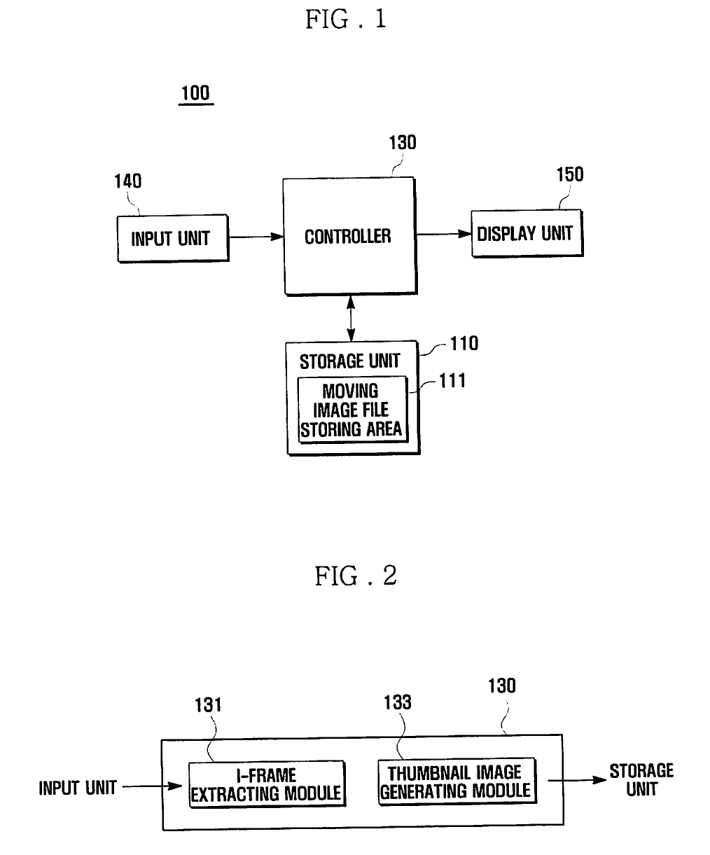

FIG. 1 is a block diagram depicting an apparatus for playing back moving image files, which adopts a method for editing a list of moving image files according to the present invention. FIG. 2 is a detailed view depicting the controller of FIG. 1.

As shown in FIGS. 1 and 2, the apparatus 100 for playing back moving image files includes an input unit 140, a controller 130, a storage unit 110, and a display unit 150.

The storage unit 110 includes a program memory and a data memory (not shown). The program memory stores an operating system for operating the moving image file playback apparatus 100 and an application program for editing a list of moving image files. The data memory stores data generated as the programs are executed. Specifically, the data memory has an area 111 for storing moving image files. The moving image file storing area 111 stores thumbnail images and moving image files including information related to the thumbnail images.

The moving image includes: ‘ftype ATOM’ having file achieve information; ‘user ATOM’ having information about types of thumbnail images; ‘thum ATOM’ having thumbnail image achieve information; ‘moov ATOM’ having meta data information; and ‘mdat ATOM’ having the original data of coded media. The ‘user ATOM’ and ‘thum ATOM’ added to the moving image is configured as follows:

The ‘user ATOM’ has the following structure:

aligned(8) class User Image extends Atom(user)
{
unsigned int(8) flag;
unsigned int(12) timestamp;
}

Here, the value of flag denotes the type of thumbnail image. For example, the thumbnail image is generated from the first I-frame or from any other I-frame in a moving image, if the value of flag is 0; from an I-frame selected by a capture signal, if the value of flag is 1; and from an I-frame selected by a successive playback function, if the value of flag is 2. The value of timestamp is effective only if the value of flag is 2. When the value of flag is 2, the timestamp denotes the time that a successive playback must be performed. For example, “timestamp is ˜”. [Storing format]

The ‘thum ATOM’ has the following structure:

aligned(8) class User Thumbnail extends Atom(user)
{
unsigned int(8) image type;
unsigned int(8) height;
unsigned int(8) width;
unsigned int(8) image[height*width*2]
}

Here, the ‘image type’ denotes color conversion information. For example, the color conversion information is indicated as: YUV4:2:0, if the image type is 0; YUV4:2:2, if the image type is 1; and RGB 565, if the image type is 2. The ‘height’ denotes height of a thumbnail image and the ‘weight’ denotes a thumbnail image area. The ‘image’ denotes data corresponding to a thumbnail image.

The input unit 140 serves as an interface for a user, and is implemented with a keypad and a touch screen, etc. The input unit 140 inputs a user command and outputs it to the controller 130. The input unit 140 outputs a control signal to the controller 130 according to user selected information such that the controller 130 performs a corresponding operation. In particular, the input unit 140 generates a capture signal or a termination signal according to user selected information. Also, the input unit 140 generates a signal for setting a successive playback function according to user selected information.

The controller 130 serves to control the entire operation of the moving image file playback apparatus 100, and in particular, to control the generation of thumbnail images of moving images. To this end, as shown in FIG. 2, the controller 130 includes a module 131 for extracting an I-frame and a module 133 for generating a thumbnail image from the extracted I-frame.

If a capture signal is generated according to user selected information during the playback of a moving image file, the controller 130 operates the I-frame extracting module 131. If the capture signal is input, the I-frame extracting module 131 extracts the displayed frame. If the displayed frame is a P-frame, the I-frame extracting module 131 selects an I-frame right next to a corresponding P-frame. The I-frame extracting module 131 outputs the selected I-frame to the thumbnail image generating module 133.

The thumbnail image generating module 133 reduces the amount of I-frame to generate a thumbnail image, so that the reduced thumbnail image can be displayed on a display screen of the moving image file playback apparatus 100. If the extracted I-frame is displayed in a thumbnail image as it was originally extracted, its loading time would be too long, and accordingly, the size of the thumbnail image file must be reduced. The size of the thumbnail image file is reduced as the capacity of the selected frame is reduced (size reduction, or quantization rate reduction, etc, for example). It is preferable that the reduction rate of a thumbnail image is predetermined (for example, the thumbnail image is 10 mm wide and 7 mm long).

The display unit 150 serves to display states and operation processes of the moving image file playback apparatus 100 under the control of the controller 130. The display unit 150 inputs display data through the input unit 140 and then display it under the controller 130. The display unit 150 displays the operation states and a variety of information of the moving image file playback apparatus 100 in text, image, animation, and icons, etc. The display unit 150 plays back moving image files under the control of the controller 130. Also, the display unit 150 displays thumbnail images of the moving image files in a list according to the control of the controller 130.

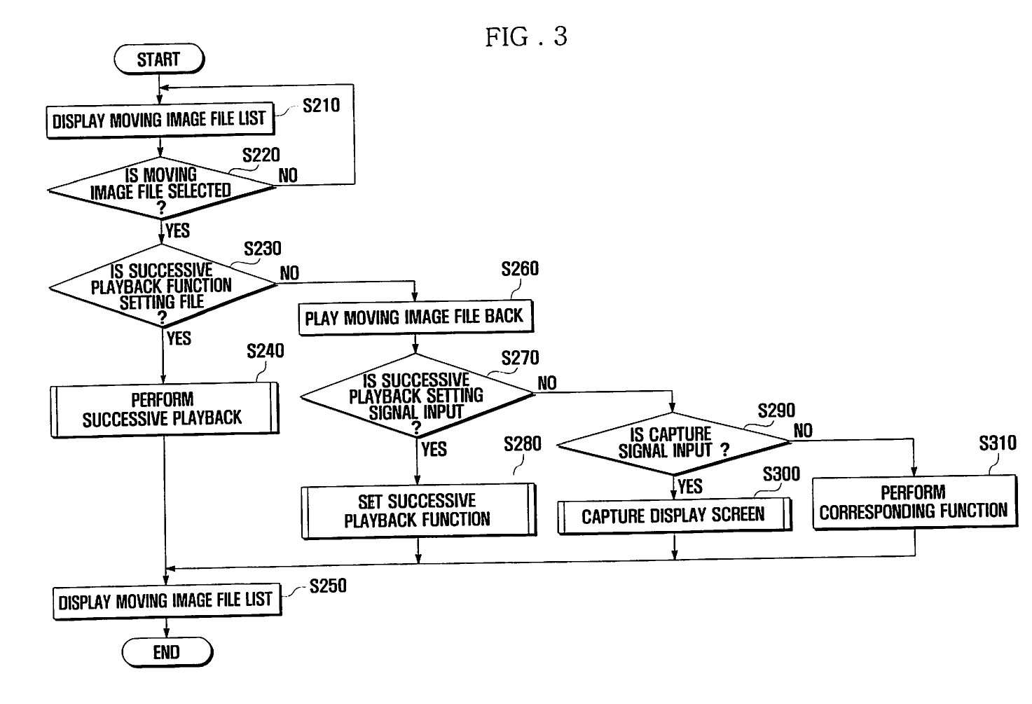

FIG. 3 is a flow chart illustrating a method for editing a list of moving image files according to the present invention.

The controller 130 displays a list of moving image files stored in the storage unit 110 in step S210, and determines whether a selection signal for a particular moving image file is input in step S220. If a selection signal is input at step S220, the controller 130 determines whether the selected moving image file is set to perform a successive playback function in step S230. The controller 130 checks the value of the flag of ‘user ATOM’ included in the moving image file to determine whether the moving image file is set to perform a successive playback function. For example, the value of the flag of a file, in which a successive playback function is set, is 2.

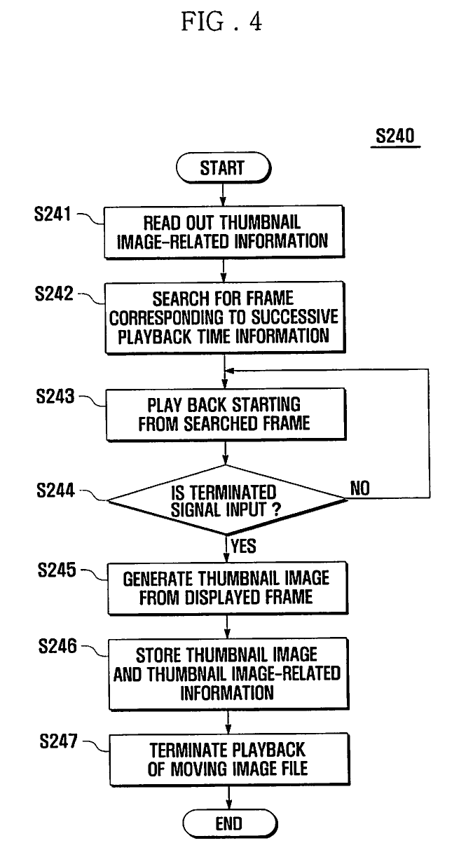

If the moving image file is set to perform a successive playback file, the controller 130 plays back a corresponding moving image file according to the successive playback function in step S240. Such a playback is described in FIG. 4 that illustrates a process for performing a successive playback function of FIG. 3.

As shown in FIG. 4, the controller 130 reads thumbnail image-related information corresponding to the selected moving image file in step S241. The controller 130 checks successive playback time information included in the read information of step S241 and searches for a frame corresponding to the successive playback time information in step S242. Specifically, the controller 130 checks whether the moving image file is set to perform the successive playback function from the value of the flag of ‘user ATOM’ that forms the moving image file. In addition, if the moving image file is set to perform a successive playback function, the value of the ‘timestamp’ indicating successive playback time information of the ‘user ATOM’ becomes effective. Therefore, when the value of flag is 2, the controller 130 checks the value of the ‘timestamp’ and searches for a frame corresponding to the value of the ‘timestamp’.

The controller 130 plays frames back starting from the searched frame on the display unit 150 in step S243. During the playback, the controller 130 determines if a termination signal is input in step S244. If the termination signal is input at step S244, the controller 130 generates a thumbnail image from the currently displayed frame in step S245. Specifically, when the termination signal is input, the controller 130 extracts a displayed frame. If the displayed frame is a P-frame, the controller 130 selects an I-frame right next to the P-frame. After that, the controller 130 generates a thumbnail image from the selected I-frame. The controller 130 generates a thumbnail image having a reduced file size from the I-frame, such that the generated thumbnail image is displayed in the list of moving image files. If the extracted I-frame is displayed in a thumbnail image as was originally extracted, its loading time would be too long. Therefore, the controller 130 reduces the size of the thumbnail image file. The size of the thumbnail image file is reduced as the capacity of the selected frame is reduced (size reduction, or quantization rate reduction, etc, for example). It is preferable that the reduction rate of a thumbnail image is predetermined (for example, the thumbnail image is 10 mm wide and 7 mm long).

The controller 130 stores the thumbnail image and the thumbnail image-related information, which are generated at step S245, in a corresponding moving image file in step S246. Specifically, the values of ‘user ATOM’ and ‘thum ATOM’ that form a moving image file are changed/set. And the controller 130 terminates the playback of the moving image file in step S247.

Returning to FIG. 3, the controller 130 displays the thumbnail image, generated through step S240 of FIG. 4, in the list of moving image files in step S250.

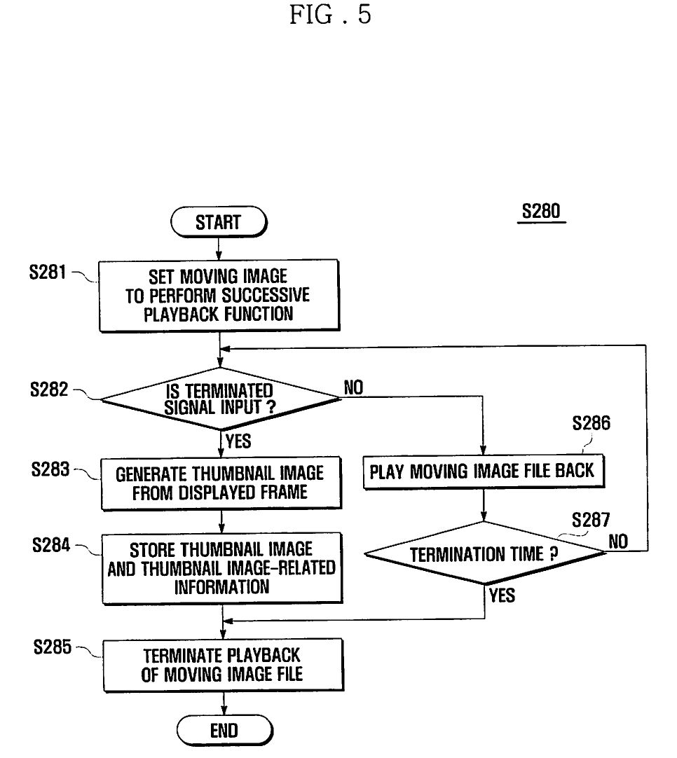

If the selected moving image file is not set to perform a successive playback function at step S230, the controller 130 controls the display unit 150 to play back a moving image file in step S260. During the playback, the controller 130 determines if a successive playback setting signal is input in step S270. If the successive playback setting signal is input at S270, the controller 130 sets the setting such that the currently playing moving image file can perform a successive playback function in step S280. Such a successive playback function is described in detail with referring to FIG. 5 that illustrates a process for setting a successive playback function of FIG. 3.

As shown in FIG. 5, the controller 130 sets the setting so that the moving image file can perform the successive playback function in step S281. During the playback of a moving image file, the controller 130 determines if a termination signal is input in step S282. If the termination signal is input, the controller 130 generates a thumbnail image from the displayed frame. The controller 130 stores the generated thumbnail image and the thumbnail image-related information in a corresponding moving image file in step S284. After that, the controller 130 terminates the currently playing moving image in step S285.

If the termination signal is not input at step S282, the controller 130 plays back the moving image file in step S286, and determines whether the moving image file arrives by the termination time in step S287. If the moving image file has arrived at the termination time, the controller 130 terminates the playback of the moving image file in step S285. As such, although the moving image file is set to perform a successive playback function, if a termination signal is not input, a default thumbnail image is displayed in the list of moving image files. Here, the default thumbnail image is generated from the first I-frame or any other I-frame in a moving image file.

If the moving image file has not arrived by the termination time at step S287, the controller 130 returns to step S282.

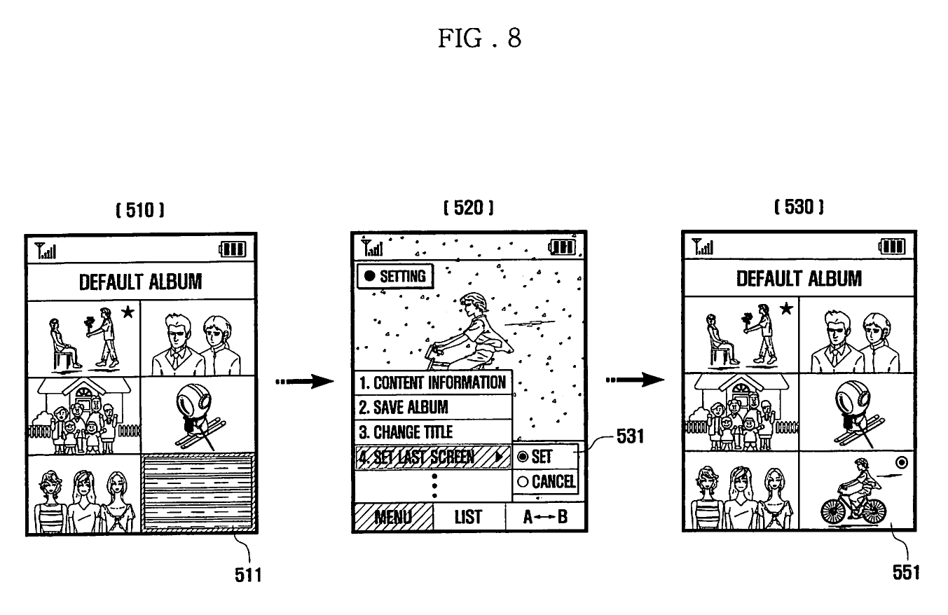

Step S280 of setting a successive playback function, described in FIG. 5, is described in FIG. 8.

FIG. 8 shows screens displaying a method for editing a list of moving image files according to another embodiment of the present invention.

As illustrated in a display screen state labeled by 510, the screen displays a list of moving images. If the cursor selects the last thumbnail image 511 positioned at the last position in the list on the screen, a moving image file corresponding to the selected thumbnail image 511 is played back on the screen as labeled by 520. During the playback of the moving image file, an item 531, ‘4. Set Last Screen’ in the menu is selected to set ‘Setting,’ as labeled by 520. After that, if a termination signal is input, a thumbnail image is generated from the displayed frame. When the list of moving image files is displayed, the last thumbnail image 511, in the display screen state labeled by 510, is displayed as a captured frame in the display screen state labeled by 530. It is preferable that the thumbnail image is displayed together with an icon, indicating that the thumbnail image is generated from the frame captured by user's capture signal. Here, the icon may be implemented by a symbol ‘⊙’ as labeled by 551.

Returning to FIG. 3, the controller 130 displays the thumbnail image generated at step S280 on the list of moving image files in step S250.

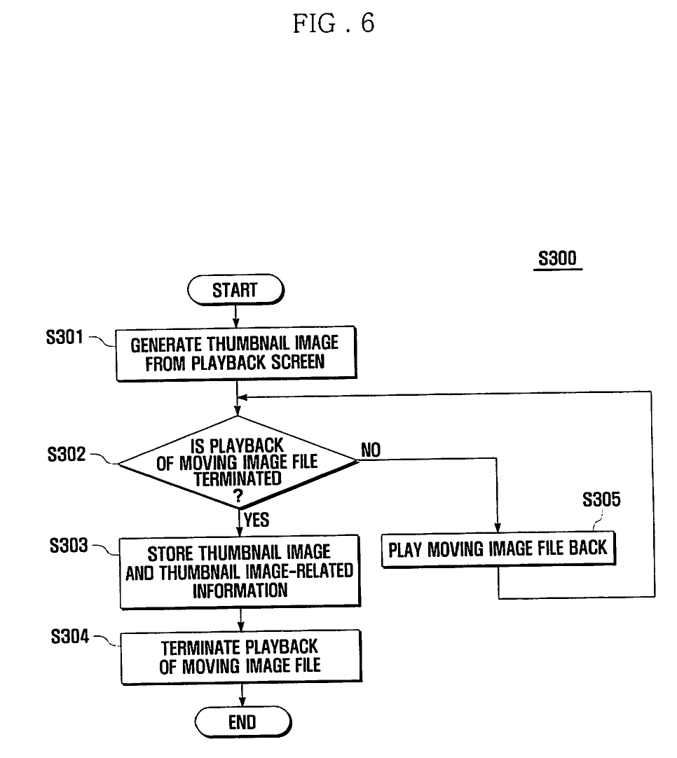

If the successive playback setting signal is not input at step S270, the controller 130 determines if a capture signal is input in step S290. If the capture signal is input, the controller 130 captures a displayed frame in step S300. The capturing process is described in detail with referring to FIG. 6, which is a flow chart illustrating a process for capturing a displayed frame of FIG. 3.

As shown in FIG. 6, the controller 130 generates a thumbnail image from the currently displayed frame in step S301. After generating the thumbnail image, the controller 130 plays back a corresponding moving image file and determines if a playback termination signal of a moving image file is input in step S302. Here, the input of the playback termination signal may be regarded as the playback termination time. If the playback termination signal of a moving image is input, the controller 130 stores the generated thumbnail image and the thumbnail image-related information in the moving image file in step S303. Specifically, the values of ‘user ATOM’ and ‘thum ATOM’ that form the moving image file are changed/set. After that, the controller 130 terminates the playback of the moving image file in step S304.

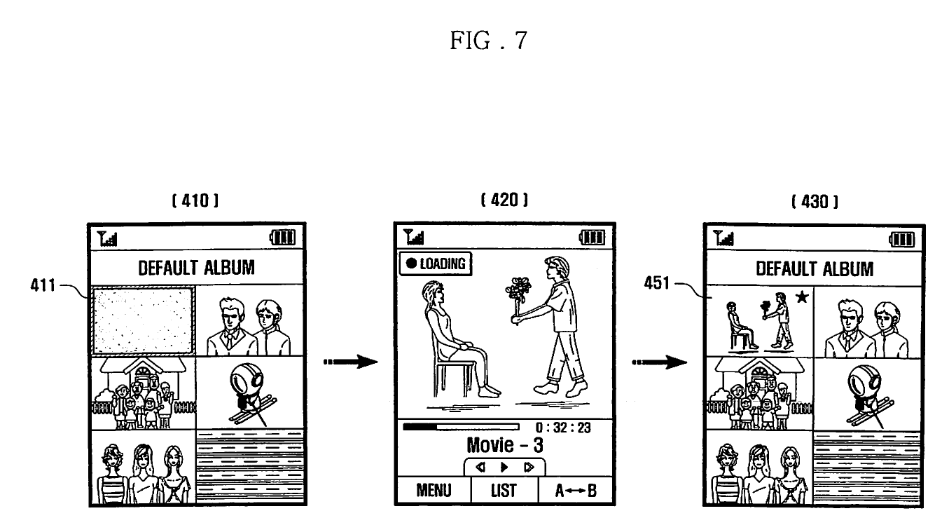

Step S300 of capturing a frame, described in FIG. 6, is described in FIG. 7.

FIG. 7 shows screens displaying a method for editing a list of moving image files according to the present invention.

As illustrated in a display screen state labeled by 410, the screen displays a list of moving image albums. If the cursor selects the first thumbnail image 411 positioned at the first location on the screen, a moving image file corresponding to the selected thumbnail image 411 is played back on the screen as labeled by 420. During the playback of the moving image file, if a capture signal is input, a thumbnail image is generated from the displayed frame as labeled by 420. Therefore, when the list of moving image files is displayed, the first thumbnail image 411, in the displayed screen state labeled by 410, is displayed as a captured frame in the display screen state labeled by 430. It is preferable that the thumbnail image is displayed together with an icon, indicating that the thumbnail image is generated from the frame captured by user's capture signal. Here, the icon may be implemented by a symbol ‘★’ as labeled by 451.

If the playback termination signal of a moving image is not input at step S302, the controller 130 plays back the moving image file in step S305, and returns to step S302 to determine if the playback termination signal is input.

Returning to FIG. 3, if the capture signal is not input at step S290, the controller 130 performs a corresponding function in step S310. For example, if the termination signal is not input, the controller 130 terminates the playback of the moving image file. In this case, it is preferable that the moving image file is set to display a default thumbnail image thereof. In another exemplary embodiment, if the successive playback function is cancelled, the controller 130 sets a thumbnail image to a default thumbnail image.

As described above, a method for editing a list of moving image files, according to the present invention, can display the contents of moving image files in the list, so that a user can easily play back his/her desired moving image file. Also, during the playback of a moving image that a successive playback function is set to perform, if a playback termination signal is input, the frame of the moving image, displayed at the time that the playback termination signal is input, is set to a thumbnail image for the played moving image. Therefore, when a user selects the moving image again, the moving image file is played back starting from the frame corresponding to the termination time. Thus the user does not need to search for the last displayed frame.

Although exemplary embodiments of the present invention have been described in detail hereinabove, it should be understood that many variations and modifications of the basic inventive concept herein described, which may appear to those skilled in the art, will still fall within the sprit and scope of the exemplary embodiments of the present invention as defined in the appended claims.

What is claimed is:

1. A method for editing a list of moving image files, comprising:
generating a thumbnail image from displayed frames, when a selection signal is input during playback of a moving image file;
storing the thumbnail image and information related to the thumbnail image; and
displaying the thumbnail image, using the thumbnail image-related information, when the list of the moving image files is displayed.

2. The method of claim 1, wherein the thumbnail image and the thumbnail image-related information are stored in the list of the moving image files when playback of the moving image file is terminated.

3. The method of claim 2, wherein the selection signal is a capture signal for capturing the displayed frame.

4. The method of claim 3, wherein the thumbnail image-related information includes at least one of height, area, and color conversion information of the thumbnail image.

5. The method of claim 2, wherein the selection signal is a termination signal for terminating playback of the moving image file.

6. The method of claim 5, wherein the thumbnail image-related information includes at least one of height, area, color conversion information, and successive playback time information of the thumbnail image.

7. The method of claim 6, further comprising:
searching a frame corresponding to the successive playback time information of the thumbnail image related-information, and a playback starting from the searched frame.
